(19) United States
(12) Patent Application Publication
(10) Pub. No.: US 2014/0362788 A1
(43) Pub. Date: Dec. 11, 2014

(54) Receiver Configuration

(71) Applicant: Broadcom Corporation, Irvine, CA (US)

(72) Inventors: Jouni Kristian KAUKOVUORI, Vantaa (FI); Antti Oskari IMMONEN, Helsinki (FI); Christopher Peter CALLENDER, Cleish (GB); Timo Eric ROMAN, Espoo (FI); Markus NENTWIG, Helsinki (FI)

(21) Appl. No.: 14/300,635

(22) Filed: Jun. 10, 2014

(30) Foreign Application Priority Data
Jun. 11, 2013 (GB) 1310397.3

(51) Int. Cl. H04L 1/00

(52) U.S. Cl. CPC H04L 1/0025; H04L 1/0036
USPC 370/329

(57) ABSTRACT

Measures, including methods, apparatus and computer software for use in a cellular telecommunications network. A network entity causes transmittal, to a user equipment comprising a receiver currently configured in a relatively low performance reception modulation state, of signaling information associated with configuration of the receiver in a relatively high performance reception modulation state and, in response to transmittal of the signaling information, the network entity receives from the user equipment an indication that downlink reception by the receiver configured in the relatively high performance reception modulation state is currently viable.

### TECHNICAL FIELD

The present invention relates to receiver configuration. In particular, but not exclusively, the present invention relates to user equipment receiver configuration in a cellular telecommunications network.

### BACKGROUND

### List of Abbreviations and Acronyms

### 3G 3^{rd} Generation

### 3GPP The 3^{rd} Generation Partnership Project

### ABS Almost Blank Subframe

### ADC Analogue to Digital Converter

### BW Bandwidth

### CA Carrier Aggregation

### CQI Channel Quality Indicator

### CRS Common Reference Symbol

### CSI Channel State Information

dB decibel

### DL Downlink

### DRX Discontinuous Reception

eICIC enhanced Inter Cell Interference Coordination
eNB evolved Node-B

### EPDCCH Enhanced Physical Downlink Control Channel

### E-UTRA Evolved Universal Terrestrial Radio Access

### EVM Error Vector Magnitude

feICIC further enhanced Inter Cell Interference Coordination

### IEEE Institute of Electrical and Electronics Engineers

### IMD Intermodulation Distortion

### LO Local Oscillator

### LS Liaison Statement

### LTE(-A) Long Term Evolution (Advanced)

### MCS Modulation and Coding Scheme

### NW Network

### PDCCH Physical Downlink Control Channel

### PN Phase Noise

### RNC Radio Network Controller

### QAM Quadrature Amplitude Modulation

### RAT Radio Access Technology

### RANI Radio Access Network Working Group 1

### RAN4 Radio Access Network Working Group 4

### RF Radio Frequency

### RFIC Radio Frequency Integrated Circuit

### RI Rank Indication

### RRC Radio Resource Control

### RX Receiver

### SINR Signal-to-Noise and Interference Ratio

### SNR Signal-to-Noise Ratio

### SX Synthesizer

### UE User Equipment

### UL Uplink

### USB Universal Serial Bus

### WLAN Wireless Local Area Network

Currently, only 64QAM reception is mandatory for UEs operating in 3G and LTE systems. Recently, 256QAM reception has been discussed in RANI as a release 12 small cell enhancement study item, and RANI sent an LS asking RAN4 to discuss EVM for both the transmitter and receiver. While this is not yet a 3GPP work item, it can be anticipated that there will be interest in defining 256QAM operation for LTE especially as 256 QAM is already included in IEEE 802.ac standards for WLAN.

FIG. 1 shows the receiver SNR 10 in baseband (EVM) curve versus real/true receiver signal level 11 of a typical UE. The solid line shows typical SNR and the dotted line shows boosted SNR. As can be seen, at low input power Pᵢₙ, additive noise from low-noise amplifier and analog baseband stages dominates and the SNR tends to increase linearly with signal strength. As can be seen, at high input power, phase noise dominates. Phase noise converts part of the received signal into noise, therefore increasing the signal power does not improve the SNR any further at high received signal strength.

The maximum receiver SNR in baseband is normally limited by the integrated PN of the synthesizer and LO generation path. In this case, the receiver SNR in baseband does not increase anymore after a certain point when the actual SNR conditions improve. To enable 256QAM reception, the receiver SNR in baseband should be increased by roughly 6 dB compared to 64QAM reception. Thus, the PN performance should be improved as well. Also, since the gain provided by the RX front-end is rather low at high input signal levels, the noise contribution of the ADC may need to be lowered; this can for example be achieved with a higher oversampling ratio. In charge sampling ADCs the current consumption increases rather linearly as a function of clocking frequency.

FIG. 2 shows an example LO phase noise spectrum plotting phase noise 20 against frequency offset from LO 21. Phase noise is caused by different mechanisms, depending on the frequency offset to the local oscillator (carrier) frequency where the phase noise is observed. At low frequency offsets, the synthesizer feedback loop and oscillator are main contributors, whereas at larger offsets the flat floor from frequency dividers and LO buffers dominates. To decrease the integrated PN level, the performance of all major noise contributors should preferably be improved; typically, this can be done by increasing the voltage swing in oscillators and buffers to achieve better carrier versus noise level, increasing supply voltage and bias level in digital frequency dividers to sharpen the waveform (to decrease the transitions time between the states as shown in the LO switching waveforms of FIG. 3) etc. The upper waveform 300 of FIG. 3 shows a rather modest LO signal with a loose transition time 301, whereas the lower waveform 310 of FIG. 3 shows a sharpened LO signal with a short transition time 311 and a higher swing. Although improved PN performance can be achieved, it has an associated drawback in the form of increased current consumption.

In typical 64QAM reception, the overall PN performance can be achieved with rather tolerable current consumption level. Since channel and interference conditions which allow 256QAM reception may occur rather rarely in small cells and maybe not at all in macro cells where interference limitations typically prevent a good enough CQI to exploit 256QAM, the UE should not be prepared for 256QAM reception all the time in order to conserve battery charge. However, in the latter situation, the UE may not be able to signal good enough performance to the eNB and the eNB cannot in turn start 256QAM transmission without proper feedback from the UE (leading to a ‘chicken-and-egg’ scenario).

The above problem could be solved by using a large amount of current in oscillators and LO path all the time. However, in typical use cases, the associated RFIC would be over-performing and thus wasting a significant amount of power, which is particularly problematic in handheld devices. In practice, such a chipset would not do well in fierce competition where current consumption is one of the key parameters.

### BRIEF DESCRIPTION OF THE DRAWINGS

FIG. 1 shows an example SNR curve for a UE receiver according to the prior art;

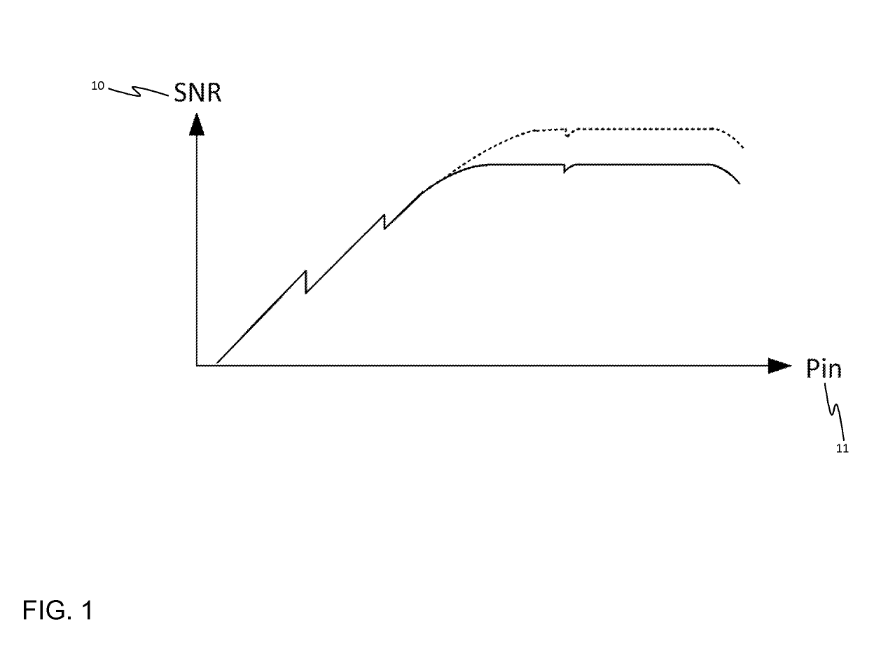

FIG. 2 shows an example LO phase noise spectrum according to the prior art;

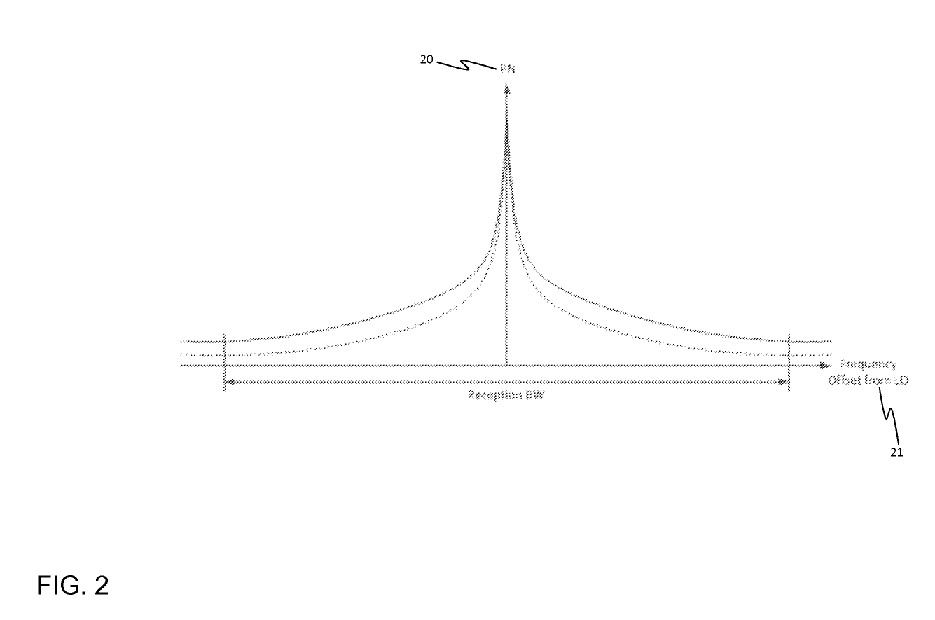

FIG. 3 shows example LO switching waveforms according to the prior art;

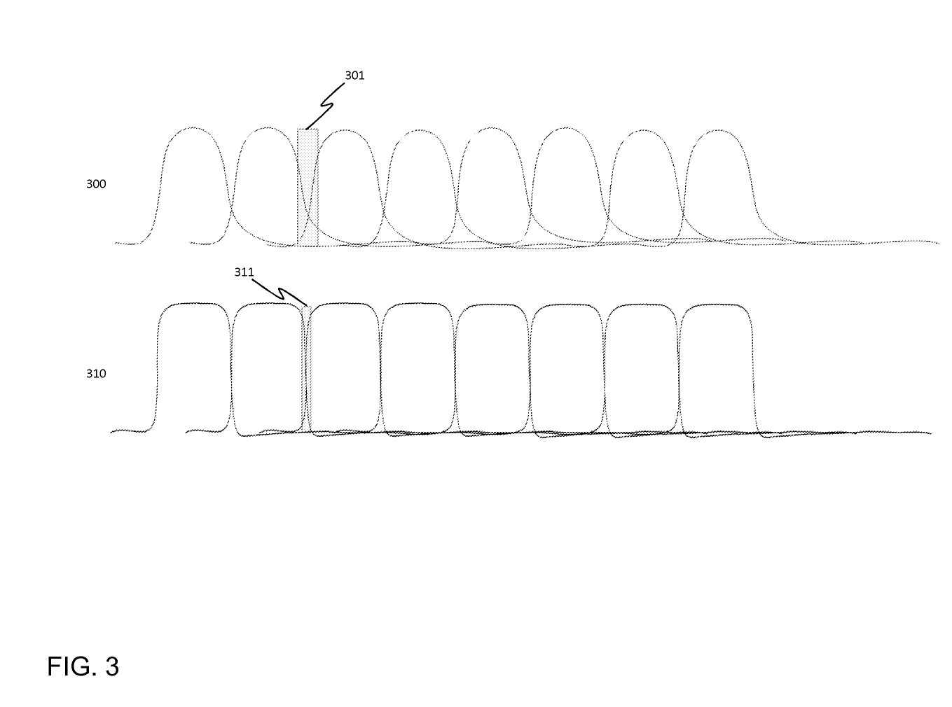

FIG. 4 shows a flow diagram according to some embodiments;

FIG. 5 shows a flow diagram according to some embodiments;

FIG. 6 shows a flow diagram according to some embodiments;

FIG. 7 shows a flow diagram according to some embodiments;

FIG. 8 shows a flow diagram according to some embodiments; and

FIG. 9 is a simplified block diagram of various example electronic devices and/or apparatus which are suitable for use in practicing some embodiments.

### DETAILED DESCRIPTION

According to a first aspect of the present invention, there is provided a method for use in a cellular telecommunications network, the method comprising, at a network entity:

causing transmittal, to a user equipment comprising a receiver currently configured in a relatively low performance reception modulation state, of signaling information associated with configuration of the receiver in a relatively high performance reception modulation state; and

in response to transmittal of the signaling information, receiving from the user equipment an indication that downlink reception by the receiver configured in the relatively high performance reception modulation state is currently viable.

According to a second aspect of the present invention, there is provided apparatus for use in a cellular telecommunications network, the apparatus being arranged to, at a network entity:

cause transmittal, to a user equipment comprising a receiver currently configured in a relatively low performance reception modulation state, of signaling information associated with configuration of the receiver in a relatively high performance reception modulation state; and

in response to transmittal of the signaling information, receive from the user equipment an indication that downlink reception by the receiver configured in the relatively high performance reception modulation state is currently viable.

According to a third aspect of the present invention, there is provided computer software for use in a cellular telecommunications network, the computer software being arranged to perform a method comprising, at a network entity:

causing transmittal, to a user equipment comprising a receiver currently configured in a relatively low performance reception modulation state, of signaling information associated with configuration of the receiver in a relatively high performance reception modulation state; and

in response to transmittal of the signaling information, receiving from the user equipment an indication that downlink reception by the receiver configured in the relatively high performance reception modulation state is currently viable.

According to embodiments, there is provided apparatus for use in a cellular telecommunications network, the apparatus comprising, at a network entity:

means for causing transmittal, to a user equipment comprising a receiver currently configured in a relatively low performance reception modulation state, of signaling information associated with configuration of the receiver in a relatively high performance reception modulation state; and

means for in response to transmittal of the signaling information, receiving from the user equipment an indication that downlink reception by the receiver configured in the relatively high performance reception modulation state is currently viable.

According to a fourth aspect of the present invention, there is provided a method for use in a cellular telecommunications network, the method comprising, at a user equipment comprising a receiver:

receiving, from a network entity, signaling information associated with configuration of the receiver in a relatively high performance reception modulation state, the receiver being currently configured in a relatively low performance reception modulation state; and

causing transmittal, to the network entity, of an indication that downlink reception by the receiver configured in the relatively high performance reception modulation state is currently viable.

According to a fifth aspect of the present invention, there is provided apparatus for use in a cellular telecommunications network, the apparatus being arranged to, at a user equipment comprising a receiver:

receive, from a network entity, signaling information associated with configuration of the receiver in a relatively high performance reception modulation state, the receiver being currently configured in a relatively low performance reception modulation state; and

cause transmittal, to the network entity, of an indication that downlink reception by the receiver configured in the relatively high performance reception modulation state is currently viable.

According to a sixth aspect of the present invention, there is provided computer software for use in a cellular telecommunications network, the computer software being arranged to perform a method comprising, at a user equipment comprising a receiver:

receiving, from a network entity, signaling information associated with configuration of the receiver in a relatively high performance reception modulation state, the receiver being currently configured in a relatively low performance reception modulation state; and

causing transmittal, to the network entity, of an indication that downlink reception by the receiver configured in the relatively high performance reception modulation state is currently viable.

According to embodiments, there is provided apparatus for use in a cellular telecommunications network, the apparatus comprising, at a user equipment comprising a receiver:

means for receiving, from a network entity, signaling information associated with configuration of the receiver in a relatively high performance reception modulation state, the receiver being currently configured in a relatively low performance reception modulation state; and

means for causing transmittal, to the network entity, of an indication that downlink reception by the receiver configured in the relatively high performance reception modulation state is currently viable.

According to a seventh aspect of the present invention, there is provided a method for use in a cellular telecommunications network, the method comprising, at a user equipment comprising a receiver:

determining that downlink reception by the receiver configured in a relatively high performance reception modulation state is currently viable, the receiver being currently configured in a relatively low performance reception modulation state; and

causing transmittal, to a network entity, of signaling information associated with the determination.

According to an eighth aspect of the present invention, there is provided apparatus for use in a cellular telecommunications network, the apparatus being arranged to, at a user equipment comprising a receiver:

determine that downlink reception by the receiver configured in a relatively high performance reception modulation state is currently viable, the receiver being currently configured in a relatively low performance reception modulation state; and

cause transmittal, to a network entity, of signaling information associated with the determination.

According to a ninth aspect of the present invention, there is provided computer software for use in a cellular telecommunications network, the computer software being arranged to perform a method comprising, at a user equipment comprising a receiver:

determining that downlink reception by the receiver configured in a relatively high performance reception modulation state is currently viable, the receiver being currently configured in a relatively low performance reception modulation state; and

causing transmittal, to a network entity, of signaling information associated with the determination.

According to embodiments, there is provided apparatus for use in a cellular telecommunications network, the apparatus comprising, at a user equipment comprising a receiver:

means for determining that downlink reception by the receiver configured in a relatively high performance reception modulation state is currently viable, the receiver being currently configured in a relatively low performance reception modulation state; and

means for causing transmittal, to a network entity, of signaling information associated with the determination.

According to a tenth aspect of the present invention, there is provided a method for use in a cellular telecommunications network, the method comprising, at a network entity:

receiving, from a user equipment comprising a receiver currently configured in a relatively low performance reception modulation state, signaling information associated with a determination made by the user equipment that downlink reception by the receiver configured in a relatively high performance reception modulation state is currently viable.

According to an eleventh aspect of the present invention, there is provided apparatus for use in a cellular telecommunications network, the apparatus being arranged to, at a network entity:

receive, from a user equipment comprising a receiver currently configured in a relatively low performance reception modulation state, signaling information associated with a determination made by the user equipment that downlink reception by the receiver configured in a relatively high performance reception modulation state is currently viable.

According to a twelfth aspect of the present invention, there is provided computer software for use in a cellular telecommunications network, the computer software being arranged to perform a method comprising, at a network entity:

receiving, from a user equipment comprising a receiver currently configured in a relatively low performance reception modulation state, signaling information associated with a determination made by the user equipment that downlink reception by the receiver configured in a relatively high performance reception modulation state is currently viable.

According to embodiments, there is provided apparatus for use in a cellular telecommunications network, the apparatus comprising, at a network entity:

means for receiving, from a user equipment comprising a receiver currently configured in a relatively low performance reception modulation state, signaling information associated with a determination made by the user equipment that downlink reception by the receiver configured in a relatively high performance reception modulation state is currently viable.

According to a thirteenth aspect of the present invention, there is provided a method for use in a cellular telecommunications network, the method comprising, at a user equipment comprising a receiver:

determining that downlink reception by the receiver configured in a relatively high performance reception modulation state is currently viable, the receiver being currently configured in a relatively low performance reception modulation state; and

in response to the determination, configuring the receiver to the relatively high performance reception modulation state.

According to a fourteenth aspect of the present invention, there is provided apparatus for use in a cellular telecommunications network, the apparatus being arranged to, at a user equipment comprising a receiver:

determine that downlink reception by the receiver configured in a relatively high performance reception modulation state is currently viable, the receiver being currently configured in a relatively low performance reception modulation state; and

in response to the determination, configure the receiver to the relatively high performance reception modulation state.

According to a fifteenth aspect of the present invention, there is provided computer software for use in a cellular telecommunications network, the computer software being arranged to perform a method comprising, at a user equipment comprising a receiver:

determining that downlink reception by the receiver configured in a relatively high performance reception modulation state is currently viable, the receiver being currently configured in a relatively low performance reception modulation state; and

in response to the determination, configuring the receiver to the relatively high performance reception modulation state.

According to embodiments, there is provided apparatus for use in a cellular telecommunications network, the apparatus comprising, at a user equipment comprising a receiver:

means for determining that downlink reception by the receiver configured in a relatively high performance reception modulation state is currently viable, the receiver being currently configured in a relatively low performance reception modulation state; and

means for, in response to the determination, configuring the receiver to the relatively high performance reception modulation state.

Embodiments comprise a computer program product comprising a non-transitory computer-readable storage medium having computer readable instructions stored thereon, the computer readable instructions being executable by a computerized device to cause the computerized device to perform a method according to any of the first, fourth, seventh, tenth or thirteenth aspects of the present invention.

Further features and advantages of the invention will become apparent from the following description of preferred embodiments of the invention, given by way of example only, which is made with reference to the accompanying drawings.

Embodiments comprise data flowing in-between a UE and NW entity of a cellular communications network and tasks performed at the UE and NW entity. The cellular telecommunications network may for example comprise an LTE or LTE-A network. The NW may for example comprise a basestation, a node B, an eNB, an RNC and/or other node of the cellular telecommunications network. The UE may for example comprise a mobile (or ‘cellular’) telephone.

First embodiments comprise measures, including methods, apparatus and computer software, for use in a cellular communications network. First embodiments involve a NW entity requesting a UE to increase (or ‘boost’) its receiver performance. For example a NW entity may request a UE to boost its receiver performance to a maximum value to check whether transmission in a modulation mode associated with a relatively high performance reception modulation state of the UE receiver can be supported in downlink in fruitful conditions (for example with good block error rate performance). In embodiments, when a UE receives the request, it starts to improve its performance, which results in increased current consumption at the UE.

In embodiments, a NW entity causes transmittal, to a UE comprising a receiver currently configured in a relatively low performance reception modulation state, of signaling information associated with configuration of the receiver in a relatively high performance reception modulation state.

In embodiments, the UE receives the signaling information from the NW entity and causes transmittal, to the NW entity, of an indication that downlink reception by the receiver configured in the relatively high performance reception modulation state is currently viable.

In embodiments, the signaling information transmitted from the NW entity to the UE comprises an explicit request for the UE to configure the receiver to the relatively high performance reception modulation state. In such embodiments involving the NW entity transmitting explicit signaling to the UE, several options exist as follows:

A first option involves explicit semi-static configuration of the ability for downlink reception by the receiver configured in the relatively high performance reception modulation state, for example via RRC signaling.

A second option involves explicit dynamic configuration of the ability for downlink reception by the receiver configured in the relatively high performance reception modulation state, for example via downlink control signaling over a PDCCH or a EPDCCH.

A third option involves explicit configuration where signaling is tied to a CSI feedback request from the NW entity to the UE. For instance, the NW entity may be aware that SNR/SINR conditions may improve at a given future time instance (for example via scheduling coordination or interference coordination) and may trigger some signaling (for example 1 bit) embedded in an aperiodic CQI request. The UE receiving such a request (with the signaling indicating that signal and interference conditions for downlink reception by the receiver configured in the relatively high performance reception modulation state may materialize) may tune/prepare its receiver to allow CQI feedback in support of potential downlink transmission in a modulation mode associated with the relatively high performance reception modulation state. The receiver setting for such a ‘boosted SNR mode’ may for example occur during a previous slot relative to a slot for which CQI has been requested.

In some embodiments, the signaling information transmitted from the NW entity to the UE comprises MCS signaling.

In some embodiments, the signaling information transmitted from the NW entity to the UE comprises data indicating that a new MCS is being taken into use which includes one or more parameters relating to downlink transmission in a modulation mode associated with the relatively high performance reception modulation state.

In some embodiments, the signaling information transmitted from the NW entity to the UE comprises data indicating that the UE is being served by a cell that supports downlink transmission in a modulation mode associated with the high performance reception modulation state.

In some embodiments, the signaling information transmitted from the NW entity to the UE comprises data indicating configuration of at least one time domain measurement restriction pattern for the UE.

In some embodiments, in response to receipt of the signaling information, the UE configures the receiver to the relatively high performance reception modulation state; in such embodiments, the indication is transmitted in response to the configuration.

In some embodiments, the configuration comprises the UE increasing the EVM performance of the receiver to a level sufficient to support downlink reception in a modulation mode associated with the relatively high performance reception modulation state. In some embodiments, the UE generates CQI measurement data on the basis of the performance of the receiver configured in the relatively high performance reception modulation state; in such embodiments, the indication comprises a CQI report comprising or derived from the generated CQI measurement data.

In some embodiments, the transmitted signaling information comprises an implicit request for the UE to configure the receiver to the relatively high performance reception modulation state. In such embodiments involving the NW entity transmitting implicit signaling to the UE, several options exist as follows:

A first option involves the NW entity indicating to the UE that a new MCS table is being taken into use which includes entries associated with downlink transmission in a modulation mode associated with the relatively high performance reception modulation state.

A second option involves use of an implicit rule which depends on CQI. For example, if a UE has been reporting a good CQI (say ≧X where X is either defined in a specification or signaled to the UE) for a predetermined time duration (again, this could be defined in a specification or signaled to the UE) the UE switches the receiver to a relatively high performance reception modulation state.

A third option involves the NW entity transmitting specific signaling (for example in a handover command) that the cell supports downlink transmission in a modulation mode associated with the high performance reception modulation state (for example a small cell, a micro cell, a pico cell or femto cell) in response to which the UE switches to a relatively high performance reception modulation state.

A fourth option involves scenarios where time domain measurement restriction patterns are configured for the UE (for example as in eICIC or feICIC), and the ability for downlink reception by the receiver configured in the relatively high performance reception modulation state is implicitly (or alternatively explicitly) tied to one of the configured patterns (for example a pattern corresponding to ABS transmission in aggressor cells because these cells are muted besides CRS transmission and overall UE receiver SNR is expected to increase significantly with respect to no-ABS sub-frames in aggressor cells).

In some embodiments, similar implicit conditions can be interpreted as a request to configure the receiver in the relatively low performance reception modulation state, for example switching to a non 256QAM MCS table, a bad CQI (≦Y say, where Y is either defined in a specification or signaled to the UE) for a predetermined time duration, handover to a non-small cell (for example a macro cell), or the like.

In some embodiments, the implicit or explicit request for the UE to configure the receiver comprises a request to increase the EVM performance of the receiver to a level sufficient to support downlink reception in the relatively high performance reception modulation state.

In some embodiments, the indication comprises a CQI report indicating sufficient performance of the receiver to support downlink reception in the relatively high performance reception modulation state.

In some embodiments, in response to receipt of the indication, the NW entity schedules downlink transmission to the UE using a modulation mode associated with the relatively high performance reception modulation state.

In some embodiments, in response to transmittal of the indication, the UE receives downlink transmission from the NW entity in the relatively high performance reception modulation state.

In some embodiments, prior to receipt of the signaling information, the UE causes transmittal of a further indication to the NW entity, the further indication indicating that the performance of the receiver exceeds that required to support downlink reception in the relatively low performance reception modulation state; in such embodiments, causing transmittal of the signaling information from the NW entity to the UE is performed in response to receipt of the further indication.

In some embodiments, prior to receipt of the signaling information, the UE causes transmittal to the NW entity, of a plurality of further indications over a predetermined period of time that the performance of the receiver exceeds that required to support downlink reception in the relatively low performance reception modulation state; in such embodiments, causing transmittal of the signaling information from the NW entity to the UE is performed in response to receipt of the further indications.

In some embodiments, prior to the configuration of the receiver, the UE generates further CQI measurement data on the basis of the performance of the receiver exceeding that required to support downlink reception in the relatively low performance reception modulation state; in such embodiments, the further indication and/or the plurality of further indications comprise one or more CQI reports comprising or derived from the further generated CQI measurement data.

In some embodiments, the signaling information transmitted from the NW entity to the UE is received at the UE in conjunction with a CSI feedback request received from the NW entity; in such embodiments the configuration of the receiver in the relatively high performance reception modulation state and the generation of the CQI measurement data are carried out at least in response to receipt of the CSI feedback request. In some embodiments, the received signaling information is comprised within the received CSI feedback request.

In some embodiments, the signaling information is transmitted from the NW entity to the UE via RRC signaling.

In some embodiments, the signaling information is transmitted from the NW entity to the UE via a PDCCH or an EPDCCH.

In some embodiments, the NW entity determines that signal and/or interference conditions for downlink transmission to the UE are to attain a level suitable for downlink transmission to the UE in a modulation mode associated with the relatively high performance reception modulation state at a given future point in time; in such embodiments, causing transmittal of the signaling information is performed at least in response to the determination.

In some embodiments, causing transmittal of the signaling information is performed in conjunction with a CSI feedback request transmitted to the UE. The transmitted signaling information may for example be comprised within the transmitted CSI feedback request.

In some embodiments, the relatively high performance reception modulation state comprises a 256 QAM or higher order modulation state. In embodiments, the relatively low performance reception modulation state comprises a lower than 256 QAM state. In some embodiments, the relatively low performance reception modulation state comprises a 64 QAM or lower order modulation state.

The relatively high performance reception modulation state typically leads to a higher associated power consumption than the relatively low performance reception modulation state. In some embodiments, the relatively high performance reception modulation state has a higher associated power consumption than the relatively low performance reception modulation state.

In some embodiments, the signaling information transmitted by the NW entity to the UE comprises a request for the UE to configure the receiver to the relatively high performance reception modulation state and once the UE receives the request, it starts to prepare its receiver for potential reception in the relatively high performance reception modulation state and thereby improves its downlink block error rate and/or throughput performance. If the UE does not understand the request (i.e. is a ‘legacy UE’), according to normal 3GPP specification procedures it does nothing. Via CSI reporting (e.g. CQI, RI, etc.), a NW entity detects whether the UE was able to reach an adequate EVM level (or adequate SNR level). Legacy UEs which cannot detect the request will tend to have inadequate SNR for reception in the relatively high performance reception modulation state (or at least meeting adequate performance may not be verified).

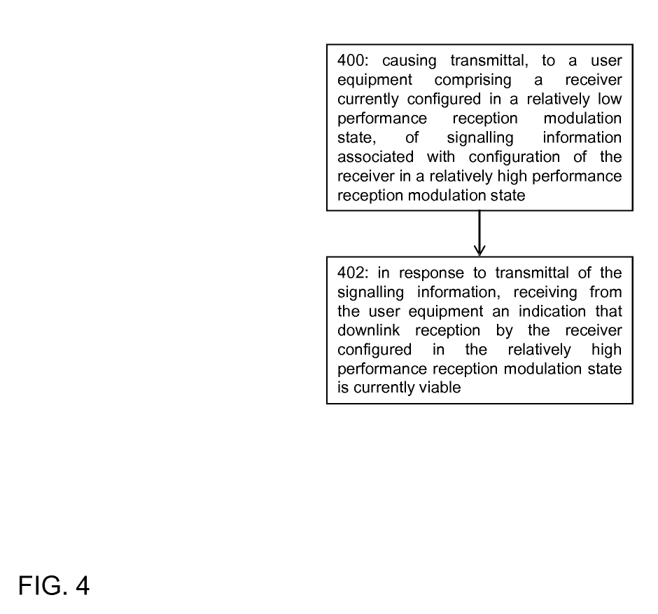

FIG. 4 shows a flow diagram according to some embodiments. In particular, FIG. 4 depicts measures for use in a cellular telecommunications network from the perspective of a NW entity (or part thereof).

Item 400 comprises causing transmittal, to a user equipment comprising a receiver currently configured in a relatively low performance reception modulation state, of signaling information associated with configuration of the receiver in a relatively high performance reception modulation state.

Item 402 comprises, in response to transmittal of the signaling information, receiving from the user equipment an indication that downlink reception by the receiver configured in the relatively high performance reception modulation state is currently viable

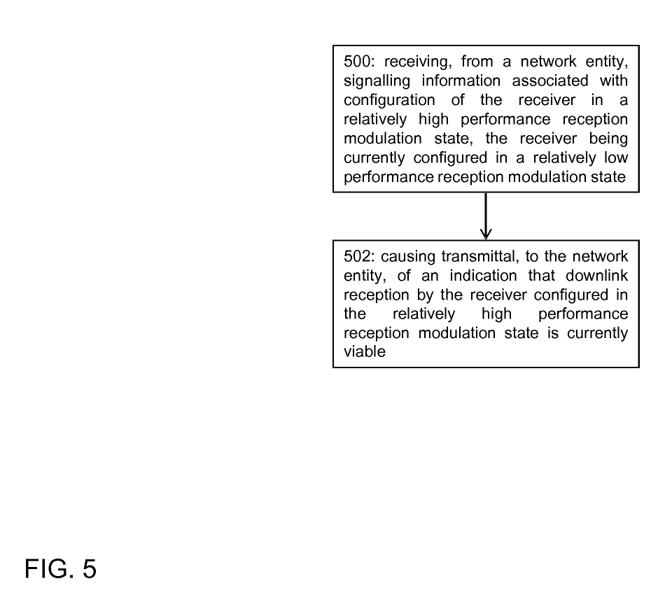

FIG. 5 shows a flow diagram according to some embodiments. In particular, FIG. 5 depicts measures for use in a cellular telecommunications network from the perspective of a UE (or part thereof e.g. a modem).

Item 500 comprises receiving, from a network entity, signaling information associated with configuration of the receiver in a relatively high performance reception modulation state, the receiver being currently configured in a relatively low performance reception modulation state.

Item 502 comprises causing transmittal, to the network entity, of an indication that downlink reception by the receiver configured in the relatively high performance reception modulation state is currently viable.

Second embodiments comprise measures, including methods, apparatus and computer software, for use in a cellular communications network. Second embodiments involve a UE informing a NW entity that it can boost receiver performance if required or desired. For example, second embodiments may involve a UE informing a NW entity that it can achieve better receiver SNR conditions.

In some embodiments, a UE comprising a receiver determines that downlink reception by the receiver configured in a relatively high performance reception modulation state is currently viable, the receiver being currently configured in a relatively low performance reception modulation state and causes transmittal, to a NW entity, of signaling information associated with the determination.

In some embodiments, the determining comprises generating CQI measurement data on the basis of the performance of the receiver configured in the relatively low performance reception modulation state; in such embodiments, the transmitted signaling information associated with the determination comprises a CQI report comprising or derived from the generated CQI measurement data.

In some embodiments, the transmitted signaling information associated with the determination comprises an indication that the generated CQI measurement data is performance limited due to configuration of the receiver in the relatively low performance reception modulation state.

In some embodiments, in response to receipt of the signaling information associated with the determination, the NW entity causes transmittal, to the UE, of a confirmation that downlink transmission in a modulation mode associated with the relatively high performance reception modulation state is supported by the NW entity.

In some embodiments, the NW entity causes transmittal, to the UE, of a notification that downlink transmission to the UE using a modulation mode associated with the relatively high performance reception modulation state has been scheduled by the NW entity.

In some embodiments, in response to receipt of the signaling information associated with the determination, the NW entity schedules downlink transmission to the UE using a modulation mode associated with the relatively high performance reception modulation state.

In some embodiments, in response to transmittal of the signaling information associated with the determination, the UE receives downlink transmission from the NW entity in the relatively high performance reception modulation state.

In some embodiments, in response to transmittal of the signaling information associated with the determination, the UE configures the receiver to the relatively high performance reception modulation state. In some embodiments, the configuration comprises increasing the EVM performance of the receiver to a level sufficient to support downlink reception in a modulation mode associated with the relatively high performance reception modulation state.

In some embodiments, the UE generates further CQI measurement data on the basis of the performance of the receiver configured in the relatively high performance reception modulation state, and causes transmittal, to the NW entity, of a further CQI report comprising or derived from the further generated CQI measurement data.

In some embodiments, the transmitted signaling information associated with the determination is transmitted by the UE (e.g. by a UE transmitter) to the NW entity (e.g. to a NW entity receiver) in capability signaling (e.g. UE capability signaling).

In some embodiments, the determination is carried out at least on the basis of knowledge of one or more communication capabilities of the UE. The one or more communication capabilities of the UE may for example be associated with at least one of linearity, SNR performance, RF filter performance, spurious rejection, power management state, a temperature detected by a sensor in the UE, antenna port activity, power of different uplinks, received signal strength, estimated interferer strength, spur conditions, potential IMD conditions, and expected data load at different radio transceivers.

In some embodiments, the UE carries out the determination (that downlink reception by the receiver configured in a relatively high performance reception modulation state is currently viable) at least on the basis of knowledge of current or expected communication via or current consumption of a WLAN transceiver of the UE.

In some embodiments, the UE carries out the determination (that downlink reception by the receiver configured in a relatively high performance reception modulation state is currently viable) at least on the basis of knowledge of a MCS which is currently being employed for downlink transmission to the UE in the relatively low performance reception modulation state.

In some embodiments, prior to causing transmittal of the signaling information associated with the determination, the UE generates yet further CQI measurement data on the basis of the performance of the receiver, the yet further generated CQI measurement data indicating that the performance of the receiver exceeds that required to support downlink reception in the relatively low performance reception modulation state; in such embodiments, the determination is carried out at least on the basis of the yet further generated CQI measurement data.

In some embodiments, the yet further CQI measurement data is generated on the basis of the performance of the receiver exceeding that required to support downlink reception in the relatively low performance reception modulation state over a predetermined period of time. In some embodiments, one or more yet further CQI reports comprising or derived from the generated yet further CQI measurement data are comprised within the transmitted data associated with the determination.

In some embodiments, the relatively high performance reception modulation state comprises a 256 QAM or higher order modulation state. In some embodiments, the relatively low performance reception modulation state comprises a lower than 256 QAM state. In some embodiments, the relatively low performance reception modulation state comprises a 64 QAM or lower order modulation state.

In some embodiments, the relatively high performance reception modulation state has a higher associated power consumption than the relatively low performance reception modulation state.

In some embodiments involving a UE informing a NW entity that it can boost receiver performance if required or desired, the UE is aware of its capabilities. In such embodiments, because the UE is aware of the current MCS it could hint to the NW entity to use a further increased modulation order to further improve its downlink throughput. If the final decision for which MCS is applied is made by the NW, the UE may boost the performance of its receiver to the relatively high performance reception modulation state after hinting to the NW entity, or the UE may wait for grant or other signaling that downlink transmission in a modulation mode associated with the relatively high performance reception modulation state has been agreed by the NW entity.

In the former scenario, the UE may start consuming more current without knowing whether downlink transmission in a modulation mode associated with the relatively high performance reception modulation state is achievable. Thus, it may be possible that the UE never needs to receive data in a modulation mode associated with the relatively high performance reception modulation state. In some cases, if data is not then received in a modulation mode associated with the relatively high performance reception modulation state, then the UE may switch its receiver back to the relatively low performance reception modulation state.

In the latter scenario, the relatively high performance reception modulation state may be used only if really needed.

In some embodiments, it is also possible that the UE indicates a hint to the NW entity that it could make use of downlink transmission in a modulation mode associated with the relatively high performance reception modulation state. However, in some such embodiments, once the UE switches the receiver to the relatively high performance reception modulation state (for example relatively high SNR/current consumption operation), the UE may not actually experience a good enough CQI for the NW entity to be able to schedule it using downlink transmission in a modulation mode associated with the relatively high performance reception modulation state (for example using a 256QAM MCS).

In some embodiments, when the UE configures its receiver to the relatively high performance reception modulation state, for example the UE adapts to a higher SNR operating environment (oscillators and/or LO operating point changed), it is possible that some data symbols can be lost if there is not sufficient time reserved for such adaptation. Such interruptions could be specified, for example in RAN4 specifications, similarly to the interruptions which are already allowed in intra-band carrier aggregation when changing reception bandwidth. Alternatively, required changes to oscillators and/or LOs when there is no data to be received could be carried out during the off part of a DRX cycle or suchlike.

In some embodiments, with regard to UE behaviour at the crossing point, i.e. at the point where SNR goes down to a level where the NW switches to downlink transmission in a modulation mode associated with the relatively low performance reception modulation state instead of the relatively high performance reception modulation state, it is desirable to avoid a ‘ping-pong’ effect between the two states. Therefore, in embodiments, the UE may attempt to boost the performance of its receiver only when the NW switches to downlink transmission in a modulation mode associated with the relatively high performance reception modulation state and to schedule the UE using a MCS associated with downlink transmission in a modulation mode associated with the relatively high performance reception modulation state, for example a 256 QAM MCS.

Furthermore, in some embodiments, a UE is aware of its activities on other RATs operating at the same time. For example, simultaneous WLAN transmission might permit or prevent downlink reception in a modulation mode associated with the relatively high performance reception modulation state at a cellular radio of the UE. For example, WLAN transmission might cause too much noise to prevent good quality downlink reception. This, however, will affect the SNR directly and thus be effective in CQI indication.

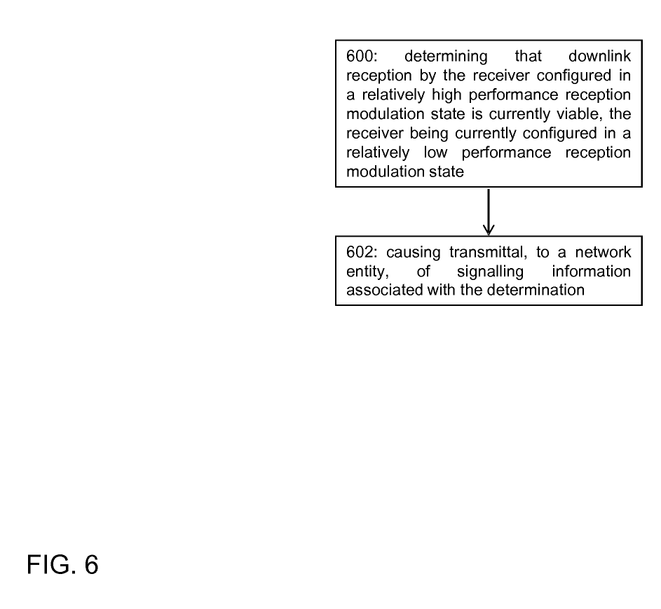

FIG. 6 shows a flow diagram according to second embodiments. In particular, FIG. 6 depicts measures for use in a cellular telecommunications network from the perspective of a UE (or part of the UE e.g. modem).

Item 600 comprises determining that downlink reception by the receiver configured in a relatively high performance reception modulation state is currently viable, the receiver being currently configured in a relatively low performance reception modulation state.

Item 602 comprises causing transmittal, to a network entity, of signaling information associated with the determination.

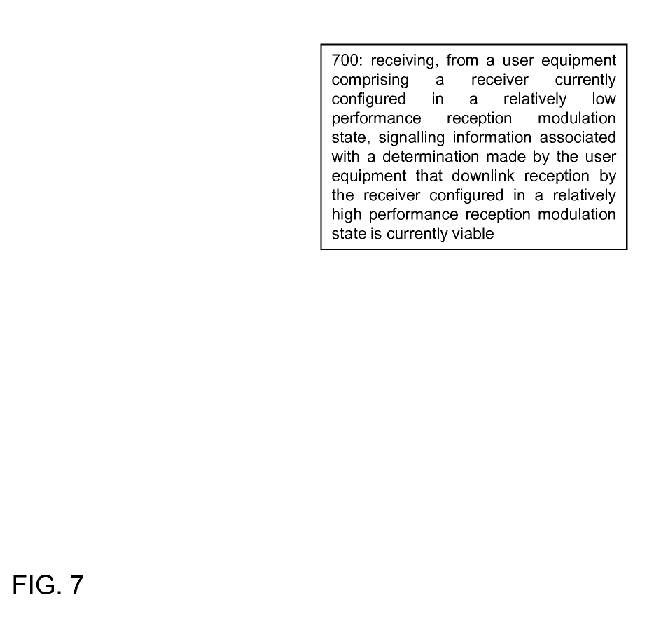

FIG. 7 shows a flow diagram according to second embodiments. In particular, FIG. 7 depicts measures for use in a cellular telecommunications network from the perspective of a NW entity.

Item 700 comprises receiving, from a user equipment comprising a receiver currently configured in a relatively low performance reception modulation state, signaling information associated with a determination made by the user equipment that downlink reception by the receiver configured in a relatively high performance reception modulation state is currently viable.

Third embodiments comprise measures, including methods, apparatus and computer software, for use in a cellular communications network. Third embodiments involve a UE enabling configuration of a receiver in a relatively high performance reception modulation state ‘blindly’ without consulting or requiring input from a NW entity.

In some embodiments, a UE comprising a receiver determines that downlink reception by the receiver configured in a relatively high performance reception modulation state is currently viable, the receiver being currently configured in a relatively low performance reception modulation state, and in response to the determination, configures the receiver to the relatively high performance reception modulation state.

In some embodiments, the configuration comprises increasing the EVM performance of the receiver to a level sufficient to support downlink reception in a modulation mode associated with the relatively high performance reception modulation state.

In some embodiments, the configuration is carried out further in response to one or more of a connection state of a charger for the UE, a power management state of the UE, a temperature detected by a sensor in the UE, other cellular RAT activity (i.e. cellular RAT activity associated with other cellular RATs supported/operated by the UE) and non-cellular RAT activity of the UE.

In some embodiments, the UE carries out the determination at least on the basis of knowledge of one or more communication capabilities of the UE. The one or more communication capabilities of the UE may for example be associated with at least one of linearity, SNR performance, radio frequency (RF) filter performance, spurious rejection, power management state, a temperature detected by a sensor in the UE, antenna port activity, power of different uplinks, received signal strength, estimated interferer strength, spur conditions, potential intermodulation distortion (IMD) conditions, and expected data load at different radio transceivers.

In some embodiments, the UE carries out the determination at least on the basis of knowledge of current or expected communication via or current consumption of a WLAN transceiver of the UE. In other embodiments, the UE carries out the determination at least on the basis of knowledge of current or expected communication via or current consumption of another non-cellular transceiver of the UE.

In some embodiments, the UE carries out the determination at least on the basis of knowledge of a MCS which is currently being employed, or which has been employed within a predetermined period of time, for downlink transmission to the UE in a modulation mode associated with the relatively low performance reception modulation state.

In some embodiments, the relatively high performance reception modulation state comprises a 256 QAM or higher order modulation state. In some embodiments, the relatively low performance reception modulation state comprises a lower than 256 QAM state. In some embodiments, the relatively low performance reception modulation state comprises a 64 QAM or lower order modulation state.

In some embodiments, the relatively high performance reception modulation state has a higher associated power consumption than the relatively low performance reception modulation state.

In some embodiments, since a UE is best aware of its capabilities/impairments (linearity, SNR performance, RF filter performance, spurious rejection, etc.), power management state, temperature (some blocks are more noisy in hot temperature conditions), activity at antenna ports (power of different uplinks, received signal strengths, spur and potential IMD conditions, etc.) and the use case (expected data load at different radios), the UE is able to determine the best cellular link to be used (for example a higher MCS or CA) at a certain time to optimize the overall data load it can handle.

Also, in some embodiments, relatively high performance modulation modes such as 256QAM tend to be low mobility solutions, so a UE can be expected to remain with the same NW entity for a while. Thus, embodiments where a UE decides to adjust its performance without NW entity assistance and boosts the performance blindly can rely on past observations, for example as follows:

In some embodiments, a UE implements an SNR boost that depends on the last time that downlink transmission is a modulation mode associated with a relatively high performance reception modulation state was received from its current NW entity.

In some embodiments, a NW entity remembers (i.e. stores and subsequently retrieves data associated with) the last time downlink transmission in a modulation mode associated with a relatively high performance reception modulation state was successfully received by a UE and schedules accordingly.

In alternative embodiments, a UE could base its maximum allowed receiver performance depending on power management state, temperature, other RAT activity, etc. For example, if a UE is not a handheld device but a data stick (for example a USB data stick), a power saving scheme can be signaled from a laptop (or other such device) via driver to the USB stick. Also, a mobile handset could base its receiver operation condition on the connection state of a charger (i.e. a UE can consume more current while the mobile handset is plugged in without having to be concerned about battery charge). Thus, when NW entity assistance is not required, a UE can configure the performance of its receiver in a relatively high performance reception modulation state blindly.

Additionally, although draining battery in a UE may not be a limiting factor, in embodiments a UE might face other maximum power limits, for example total dissipated power of the device can be limited due to thermal reasons.

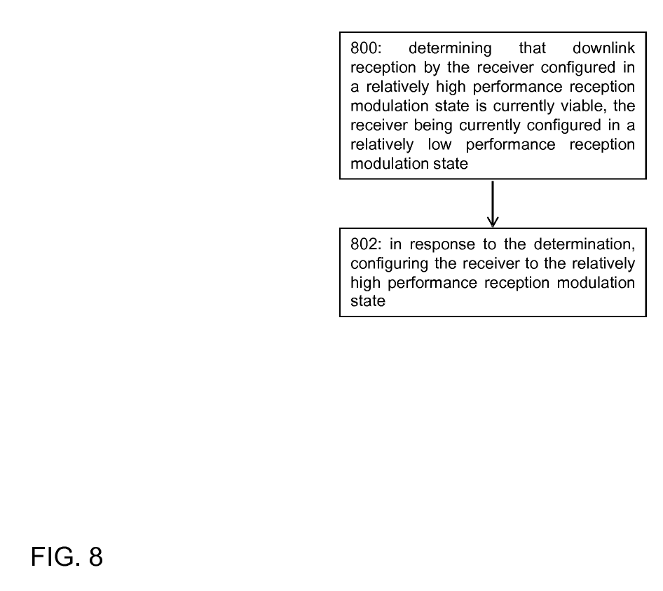

FIG. 8 shows a flow diagram according to third embodiments. In particular, FIG. 8 depicts measures for use in a cellular telecommunications network from the perspective of a UE (or part of the UE e.g. a modem).

Item 800 comprises determining that downlink reception by the receiver configured in a relatively high performance reception modulation state is currently viable, the receiver being currently configured in a relatively low performance reception modulation state.

Item 802 comprises, in response to the determination, configuring the receiver to the relatively high performance reception modulation state.

FIGS. 4 to 8 represent results according to embodiments of executing a computer program or an implementing algorithm stored in the local memory of a UE (see FIGS. 5, 6 and 8) or a NW entity (see FIGS. 4 and 7) respectively as well as illustrating the operation of a method and a specific manner in which the processing system and/or processor and memory with computer program/algorithm are configured to cause one or more of a UE or NW entity respectively (or one or more components thereof) to operate. The various blocks shown in these figures may also be considered as a plurality of coupled logic circuit elements constructed to carry out the associated function(s), or specific result or function of strings of computer program code stored in a computer readable memory. Such blocks and the functions they represent are non-limiting examples, and may be practiced in various components such as integrated circuit chips and modules, and that embodiments of the present invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with embodiments of the present invention.

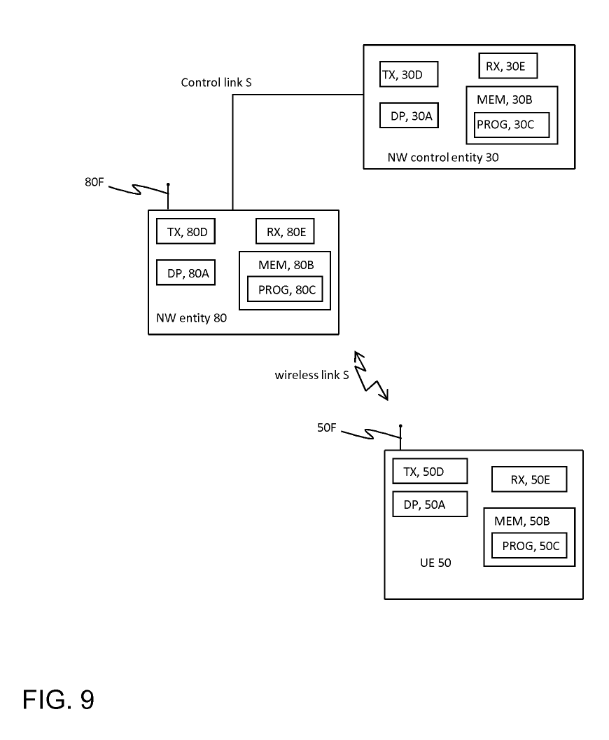

Reference is now made to FIG. 9 which illustrates a simplified block diagram of various example electronic devices and/or apparatus that are suitable for use in practicing embodiments of the present invention. In FIG. 9, NW entity 80 is adapted for communication over a wireless link S with a UE 50, such as a mobile terminal. NW entity 80 may comprise a macro Node B, an eNodeB, a remote radio head, relay station, a femto cell or home NodeB, or other type of base station/cellular network access node.

UE 50 may include processing means such as a processing system and/or at least one data processor (DP) 50A, storing means such as at least one computer-readable memory (MEM) 50B storing at least one computer program (PROG) 50C, and also communicating means such as a transmitter TX 50D and a receiver RX 50E for bidirectional wireless communications with the NW entity 80 and/or any neighboring cells (not shown) via one or more antennas 50F. Note that embodiments may be carried out by apparatus such as a modem which does not comprise an antenna.

NW entity 80 includes its own processing means such as a processing system and/or at least one data processor (DP) 80A, storing means such as at least one computer-readable memory (MEM) 80B storing at least one computer program (PROG) 80C, and communicating means such as a transmitter TX 80D and a receiver RX 80E for bidirectional wireless communications with other devices under its control via one or more antennas 80F. There is a data and/or control path, termed at FIG. 9 as a control link S which in the 3GPP cellular system may be implemented as an Iub interface or in E-UTRAN as an S1 interface, coupling the NW entity 80 with network control entity 30, and over which network control entity 30 and NW entity 80 may exchange control messages, such as system information update requests and/or change notifications. Network control entity 30 may in an example case of a UTRAN network comprise an RNC and in the example case of a E-UTRAN network comprise a Mobility Management Entity (MME), Serving Gateway (S-GW), Packet Data Network Gateway (P-GW) or suchlike.

Network control entity 30 includes processing means such as a processing system and/or at least one data processor (DP) 30A and storing means such as at least one computer-readable memory (MEM) 30B storing at least one computer program (PROG) 30C. Network control entity 30 may for example comprise data transmission means 30D and data reception means 30E for bidirectional communication with NW entity 80 over control link S.

Whilst not particularly illustrated for UE 50 and NW entity 80, either of those devices/entities/elements may include as part of wireless communicating means a modem which may be inbuilt on a RF front end chip within those devices 50, 80 and which chip also carries the TX 50D/80D and the RX 50E/80E.

Various embodiments of UE 50 can include, but are not limited to: mobile telephones (or ‘cellular’ telephones) including so-called smartphones; data cards, USB dongles, laptop computers, personal portable digital devices having wireless communication capabilities including but not limited to laptop/palmtop/tablet/phablet computers, digital cameras and music devices, Internet appliances, and machine type devices such as smart meters, smart sensors, vending machines, gaming machines, point of sale machines, etc.

At least one of the PROGs 50C in UE 50 is assumed to include program instructions that, when executed by the associated DP 50A, enable the device to operate in accordance with embodiments of the present invention, as detailed above. NW entity 80 and network control entity 30 also have software stored in their respective MEMs to implement certain aspects of these teachings. In these regards, embodiments of this invention may be implemented at least in part by computer software stored on the MEM 50B, 80B, 30B which is executable by the DP 50A of UE 50, DP 80A of NW entity 80 and/or DP 30A of network control entity 30, or by hardware, or by a combination of tangibly stored software and hardware (and tangibly stored firmware). Electronic devices implementing these aspects of the invention need not be the entire devices as depicted at FIG. 9, but embodiments may be implemented by one or more components of same such as the above described tangibly stored software, hardware, firmware and DP, or a system on a chip SOC, an application specific integrated circuit ASIC or a digital signal processor DSP.

Various embodiments of the computer readable MEMs 50B, 80B and 30B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 50A, 30A and 80A include but are not limited to general purpose computers, special purpose computers, microprocessors, digital signal processors (DSPs) and multi-core processors.

Method steps and/or devices, apparatuses, units or means likely to be implemented as hardware components at a terminal or network entity/element, or any module(s) thereof, are hardware independent and can be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), graphene, ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components.

The above embodiments are to be understood as illustrative examples of the invention. Further embodiments of the invention are envisaged.

The term embodiment herein should be taken to mean an example and the term embodiments herein should be taken to mean some examples, such that description of an embodiment or embodiments refers to some embodiments, but not necessarily all embodiments.

In embodiments described above, the NW entity carries out various data processing tasks. In alternative embodiments, the NW entity may initiate one or more such tasks and be assisted by one or more other network entities in performing those tasks. In further alternative embodiments, some of the tasks of the NW entity are carried out by multiple nodes, for example some tasks are carried out by an eNB and other tasks are carried out by an RNC.

Embodiments described above involve data flowing in-between a UE and a NW entity of a cellular communications network and tasks performed at the UE and NW entity. Alternative embodiments involve direct device-to-device (D2D) communication with data flowing in-between two UEs, for example 256QAM transmission from one UE to another UE receiving the 256QAM transmission. In such alternative embodiments, the NW entity exemplified in embodiments above can also be considered as a UE itself (or in other words, one UE acts as a NW entity towards its D2D pair UE).

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method for use in a cellular telecommunications network, the method comprising, at a network entity:
causing transmittal, to a user equipment comprising a receiver currently configured in a relatively low performance reception modulation state, of signaling information associated with configuration of the receiver in a relatively high performance reception modulation state; and
in response to transmittal of the signaling information, receiving from the user equipment an indication that downlink reception by the receiver configured in the relatively high performance reception modulation state is currently viable.

2. The method according to claim 1, wherein the transmitted signaling information comprises at least one of:
an explicit request for the user equipment to configure the receiver to the relatively high performance reception modulation state,
modulation and coding scheme (MCS) signaling,
a first data indicating that a new MCS is being taken into use which includes one or more parameters relating to downlink transmission in a modulation mode associated with the relatively high performance reception modulation state,
a second data indicating that the user equipment is being served by a cell that supports downlink transmission in a modulation mode associated with the high performance reception modulation state,
a third data indicating configuration of at least one time domain measurement restriction pattern for the user equipment, and
an implicit request for the user equipment to configure the receiver to the relatively high performance reception modulation state.

3-21. (canceled)

22. An apparatus for use in a cellular telecommunications network, the apparatus comprising a processing system, including at least one data processor and at least one computer-readable memory, configured to, at a network entity:
cause transmittal, to a user equipment comprising a receiver currently configured in a relatively low performance reception modulation state, of signaling information associated with configuration of the receiver in a relatively high performance reception modulation state; and
in response to transmittal of the signaling information, receive from the user equipment an indication that downlink reception by the receiver configured in the relatively high performance reception modulation state is currently viable.

23. The apparatus according to claim 22, wherein the transmitted signaling information comprises an explicit request for the user equipment to configure the receiver to the relatively high performance reception modulation state.

24. The apparatus according to claim 22, wherein the transmitted signaling information comprises modulation and coding scheme (MCS) signaling.

25. The apparatus according to claim 22, wherein the transmitted signaling information comprises data indicating that a new MCS is being taken into use which includes one or more parameters relating to downlink transmission in a modulation mode associated with the relatively high performance reception modulation state.

26. The apparatus according to claim 22, wherein the transmitted signaling information comprises data indicating that the user equipment is being served by a cell that supports downlink transmission in a modulation mode associated with the high performance reception modulation state.

27. The apparatus according to any of claim 22, wherein the transmitted signaling information comprises data indicating configuration of at least one time domain measurement restriction pattern for the user equipment.

28. The apparatus according to any of claim 24, wherein the transmitted signaling information comprises an implicit request for the user equipment to configure the receiver to the relatively high performance reception modulation state.

29. The apparatus according to claim 28, wherein the implicit or explicit request for the user equipment to configure the receiver comprises a request to increase the error vector magnitude (EVM) performance of the receiver to a level sufficient to support downlink reception in the relatively high performance reception modulation state.

30. The apparatus according to claim 22, wherein the indication comprises a channel quality indicator (CQI) report indicating sufficient performance of the receiver to support downlink reception in the relatively high performance reception modulation state.

31. The apparatus according to any claim 22, the processing system being configured to, in response to receipt of the indication, schedule downlink transmission to the user equipment using a modulation mode associated with the relatively high performance reception modulation state.

32. The apparatus according to claim 22, the processing system being configured to, prior to causing transmittal of the signaling information, receive at least one further indication from the user equipment, the further indication indicating that the performance of the receiver exceeds that required to support downlink reception in the relatively low performance reception modulation state,
wherein causing transmittal of the signaling information is performed in response to receipt of the further indication.

33. (canceled)

34. The apparatus according to claim 32, wherein the further indication and/or the plurality of further indications comprise one or more CQI reports indicating the performance of the receiver exceeding that required to support downlink reception in the relatively low performance reception modulation state.

35. The apparatus according to claim 22, wherein the signaling information is transmitted via radio resource control (RRC) signaling, wherein the signaling information is transmitted via physical downlink control channel (PDCCH) or an enhanced physical downlink control channel (EPDCCH).

36. (canceled)

37. The apparatus according to claim 22, the processing system being configured to determine that signal and/or interference conditions for downlink transmission to the user equipment are to attain a level suitable for downlink transmission to the user equipment in a modulation mode associated with the relatively high performance reception modulation state at a given future point in time,
wherein causing transmittal of the signaling information is performed at least in response to the determination.

38. The apparatus according to claim 37, wherein causing transmittal of the signaling information is performed in conjunction with a channel state information (CSI) feedback request transmitted to the user equipment,
wherein the transmitted signaling information is comprised within the transmitted ESI feedback request.

39. (canceled)

40. The apparatus according to claim 22, wherein the relatively high performance reception modulation state comprises a 256 quadrature amplitude modulation (QAM) or higher order modulation state, while the relatively low performance reception modulation state comprises a 64 QAM or lower order modulation state.

41. (canceled)

42. The apparatus according to any of claim 22, wherein the relatively high performance reception modulation state has a higher associated power consumption than the relatively low performance reception modulation state.

43-63. (canceled)

64. An apparatus for use in a cellular telecommunications network, the apparatus comprising a processing system, including at least one data processor and at least one computer-readable memory, configured to, at a user equipment comprising a receiver:
receive, from a network entity, signaling information associated with configuration of the receiver in a relatively high performance reception modulation state, the receiver being currently configured in a relatively low performance reception modulation state; and
cause transmittal, to the network entity, of an indication that downlink reception by the receiver configured in the relatively high performance reception modulation state is currently viable.

65-170. (canceled)
